(19) United States
(12) Patent Application Publication
(10) Pub. No.: US 2006/0253783 A1
(43) Pub. Date: Nov. 9, 2006

(54) STORY TEMPLATE STRUCTURES ASSOCIATED WITH STORY ENHANCING CONTENT AND RULES

(75) Inventors: David P. Vronay, Beijing (CN); Shuo Wang, Beijing (CN); Xiang-Sheng Hua, Beijing (CN); Xiao-Ming Simon Ji, Beijing (CN)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: MICROSOFT CORPORATION, REDMOND, WA (US)

(21) Appl. No.: 10/908,376

(22) Filed: May 9, 2005

(51) Int. Cl. G06F 17/00

(52) U.S. Cl. 715/730; 715/500.1; 715/515; 715/530

(57) ABSTRACT

Story events may be obtained from a media collection from which a structured story may be generated. Story template structures are provided that may include template content which may convey one or more well-known abstract meanings, such as emotions or popular media themes (e.g., movies). The story template structures may also include template rules that may ensure the story events are formatted in a manner substantially consistent with the well-known abstract meanings intended to be conveyed. The story events obtained from the media collection may be organized within the story template structures so that the template rules are applied to the events and the well-known abstract meanings are associated with the events. This ensures that the story events in the structured story may be presented in a coherent manner that conveys the desired abstract meanings for particular story events.

### TECHNICAL FIELD

The technology relates generally to story rendering techniques and, more particularly, to story template structures that may be associated with story enhancing content and rules for generating structured story narrations that may convey contextual information associated with one or more portions of the story content from the structured story narrations.

### BACKGROUND

With advances in digital camera technology, the popularity of digital photography among average people has increased. One of the benefits to using digital cameras is that a large number of digital images may be captured, stored, manipulated, edited and shared using the digital cameras and other computing resources. Digital images may also be captured from traditional film media with digital scanning devices. Some digital images are even created virtually using a computer, for example.

Once a collection of digital images has been captured and stored, users may want to decide what to do with the digital images. There are a variety of different digital image handling tools available to users. By way of example only, users may edit digital images using photo editing applications, transfer digital images to servers on the Internet or other like networks to make the images available to others, print the digital images, and/or organize the digital images into virtual photo albums, web sites, collages, and/or slide shows.

### BRIEF DESCRIPTION OF THE DRAWINGS

The following disclosed technology will become more readily appreciated as the same becomes better understood by reference to the following detailed description, when taken in conjunction with the accompanying drawings, wherein:

FIG. 1 is a functional block diagram providing a high-level illustration of an example of a story structuring process-flow that may be implemented to generate a structured story;

FIG. 2 is a block diagram of an example of a computing device in which a story structuring system may be implemented;

FIG. 3 is a block diagram of an example of a story structuring system that may be implemented to generate a structured story;

FIG. 4 is a block diagram of an example of a story template structure that may be implemented in the exemplary story structuring system illustrated in FIG. 3;

FIG. 5 is a block diagram of an example of a story template slot structure that may be defined in the exemplary story template structure illustrated in FIG. 3;

FIG. 6 is a flow chart of an example of a method for organizing user media collections into structured stories;

FIG. 7 is a functional block diagram of an example of a manner in which components from the story structuring system illustrated in FIG. 3 may interact with each other during performance of the exemplary method illustrated in FIG. 6;

FIG. 8 is a diagram of an example of a graphical user interface that may be employed by the story structuring system illustrated in FIG. 3 to obtain information from users during performance of the exemplary method illustrated in FIG. 6;

FIG. 9 is a flow chart of an example of a method for presenting a structured story that may have been generated by the exemplary story structuring system illustrated in FIG. 3; and

FIG. 10 is a functional block diagram of an example of the structured story being presented in the exemplary method illustrated in FIG. 9.

### DETAILED DESCRIPTION

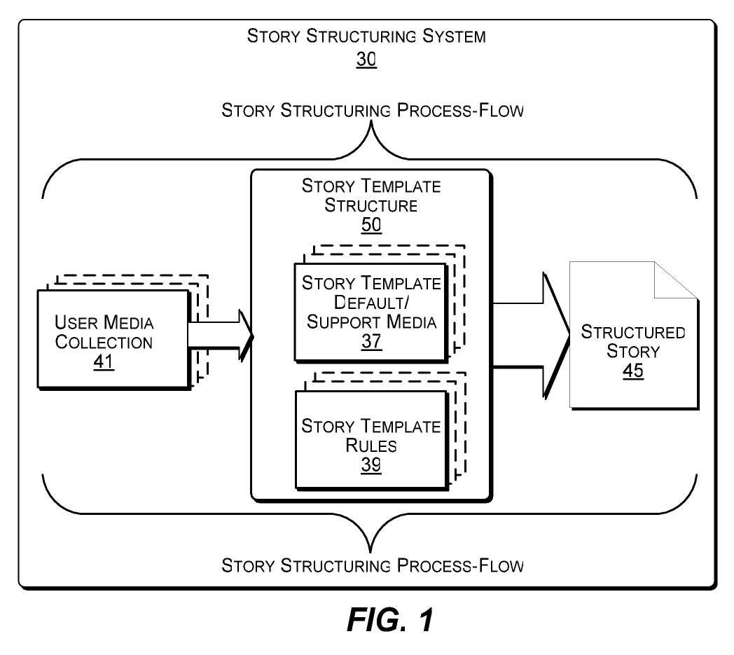

FIG. 1 is a functional block diagram depicting an exemplary story structuring process-flow that may be implemented in conjunction with story structuring system 30, for example. The exemplary story structuring process-flow depicted in FIG. 1 and discussed herein is presented to provide a high-level introduction for at least some of the concepts from this disclosure as a precursor to a more detailed description provided further herein below of these and other concepts. As such, the exemplary story structuring process-flow may be implemented to generate structured story 45. Structured story 45 may represent a narration involving one or more captured events obtained from user media collection 41 that may be structured to convey one or more abstract meanings that may be associated with the events when presented in the narration. User media collection 41 may represent any type of content that may express information in some manner based on the particular type of content. For instance, user media collection 41 may represent events that may take place during a family vacation that may be captured in digital pictures.

Story structuring system 30 may enable users to leverage the story structuring process-flow in a manner that allows users to simply make high-level emotional decisions when one or more portions of user media collection 41 are structured to generate structured story 45. Moreover, from the user's perspective, story structuring system 30 may automatically implement the story structuring process-flow by requesting that the high-level emotional decisions be made by the users when the one or more portions of user media collection 41 are being structured during the structuring process flow, for example.

By way of example only, the user may associate events captured in user media collection 41 with a tragic historic event, such as when the RMS Titanic struck an iceberg and sank in the North Atlantic Ocean in 1912. The story structuring system 30 may include one or more story template structures 50 defined with default/support media 37 and/or story template rules 39 that may convey such a tragic abstract meaning. Thus, the user may simply select such a story template structure 50 and the story structuring system 30 may then structure the user media collection 41 in a manner that may express the notion of such tragic events when one or more portions of structured user media collection 41 may be presented within structured story 45.

Users may desire communicating or sharing events captured in user media collection 41 in the form of a story since these events may be related to each other in some fashion. Referring back to the earlier family vacation example, at least some of the captured events from user media collection 41 may correspond to things that may occur in a particular timeframe during the vacation. In particular, events that may take place during a sightseeing tour during the vacation may be captured in the digital pictures.

Furthermore, users may sometimes subjectively associate one or more captured events with particular emotions, feelings, moods, thoughts, memories, or any other abstract meaning. For instance, and referring back to the earlier family vacation example, a particular captured event in user media 41 may represent a digital picture taken of the family while standing in front of a non-descript house that may have belonged to the family's first ancestor to obtain citizenship in this country. While each of the family members may subjectively associate the captured event with one or more emotions, the emotional significance of this event may not be recognized by others that may not be aware of the family's ancestral connection with the non-descript house.

However, the family members in the example above may desire conveying the emotional significance of the particular event to those that may not otherwise appreciate their significance when the captured events in user media collection 41 are shared in the form of a story. Unfortunately, users may find it difficult if not impossible to effectively convey such abstract meanings for a number of reasons. For instance, these users may lack sufficient narrative, editorial, design, technical or other skills needed to modify or enhance the captured events in user media collection 41 to ensure the desired abstract meanings are conveyed without obfuscating the story. In general, users may find it difficult to organize events captured in user media collection 41 in a coherent manner to create compelling and emotionally significant stories for sharing the events. Consequently, the captured events may be haphazardly arranged in such a manner that the narrative structure of a story formed from those events may lack consistency and result in ineffective stories.

The exemplary story structuring process-flow depicted in FIG. 1 may address at least some of the issues noted above. Story template structure 50 in story structuring system 30 may be leveraged to structure captured events obtained from user media 41, for example, in a compelling and coherent manner that may ensure that the desired abstract meanings associated with the events is conveyed, although the story structuring process-flow may be implemented by other systems and/or other issues may be addressed.

With continued reference to FIG. 1, a more specific overview of an exemplary implementation of the story structuring process-flow will now be described. Generally, story structuring system 30 may leverage story template structure 50, which may be associated with story template default/support media 37 and story template rules 39, for structuring one or more portions of user media collection 41 to generate structured story 45. In particular, one or more captured events that the user may desire basing structured story 45 on may be obtained from user media collection 41 based on some criteria. Users may select story template structure 50 based on a particular story theme context that may be conveyed by the template structure 50's associated story template default/support media 37 and/or story template rules 39. Users may desire associating their captured events with a particular story template structure 50 so they may be able to express any underlying meanings they may associate with those events that may correspond to the template 50's corresponding story theme.

The portions of the particular story theme context expressed by story template default/support media 37 and/or story template rules 39 associated with the selected story template structure 50 may convey underlying meanings, such as a particular emotional context (e.g., happiness, nostalgia, sadness) or any other type of context, in an objective manner. This way, a greater number of users may be able to recognize the underlying objective meanings associated with captured events structured into structured story 45 that may not otherwise be possible when the associated underlying meanings are conveyed in a subjective manner. Further, story structuring system 30 may leverage story template structure 50 to enable users to easily structure captured events from user media collection 41 to communicate these events in the form of a coherent story represented by structured story 45.

Still further, story structuring system 30 may allow users to narrate their captured events in a particular manner defined by story template structure 50 to further enhance structured story 45. As a result, users may be able to focus their efforts on deciding which story template structure 50 to select for structuring their captured events based on the template's associated story theme context instead of struggling to find ways for explicitly expressing any underlying meanings desired to be associated and conveyed in structured story 45.

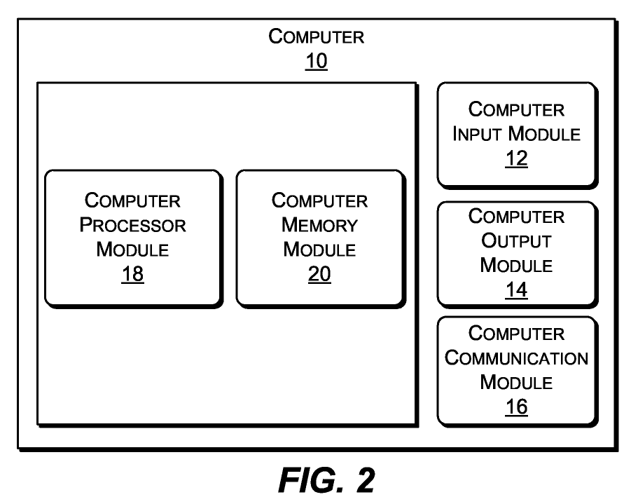

Referring now generally to FIGS. 2-5 with occasional reference back to FIG. 1, computer 10 may be employed to implement story structuring system 30. Generally, story structuring system 30 may implement story template structure 50 having one or more story template slot structure(s) 54 into which one or more portions of user media collection 41 may be structured or organized to generate the structured story 45. As such, computer 10, story structuring system 30, story template structure 50 and story template slot structure(s) 54 will now be described in further detail herein.

FIG. 2 illustrates an example of a suitable operating environment presented as computer 10 in which story structuring system 30 may be implemented as mentioned above. The exemplary operating environment illustrated in FIG. 2 is not intended to suggest any limitation as to the scope of use or functionality of story structuring system 30. Other types of computing systems, environments, and/or configurations that may be suitable for use with story structuring system 30 may include, but are not limited to, hand-held, notebook or laptop devices, multiprocessor systems, microprocessor-based systems, programmable consumer electronics, network PCs, minicomputers, mainframe computers, distributed computing environments that may include any of the above systems or devices, and other systems.

As such, computer 10 in its most basic configuration may comprise computer input module 12, computer output module 14, computer communication module 16, computer processor module 18 and computer memory module 20, which may be coupled together by one or more bus systems or other communication links, although computer 10 may comprise other modules in other arrangements. Computer input module 12 may comprise one or more user input devices, such as a keyboard and/or mouse, and any supporting hardware. Computer input module 12 may enable a user who is operating computer 10 to generate and transmit signals or commands to computer processor module 18.

Computer output module 14 may comprise one or more user output devices, such as a computer monitor (e.g., CRT, LCD or plasma display) and/or printer, and any supporting hardware, although other types of output devices may be used. Computer output module 14 may present one or more results from computer processor module 18 executing instructions stored in computer memory module 20.

Computer communication module 16 may comprise one or more communication interface devices, such as a serial port interface (e.g., RS-232), a parallel port interface, a wire-based (e.g., Ethernet) or wireless network adapter, and any supporting hardware, although other types of communication interface devices may be used. Computer communication module 16 may enable computer 10 to transmit data to and receive data from other computing systems or peripherals (e.g., external memory storage device, printer or other computing system) via one or more communication media, such as direct cable connections and/or one or more types of wireless or wire-based networks.

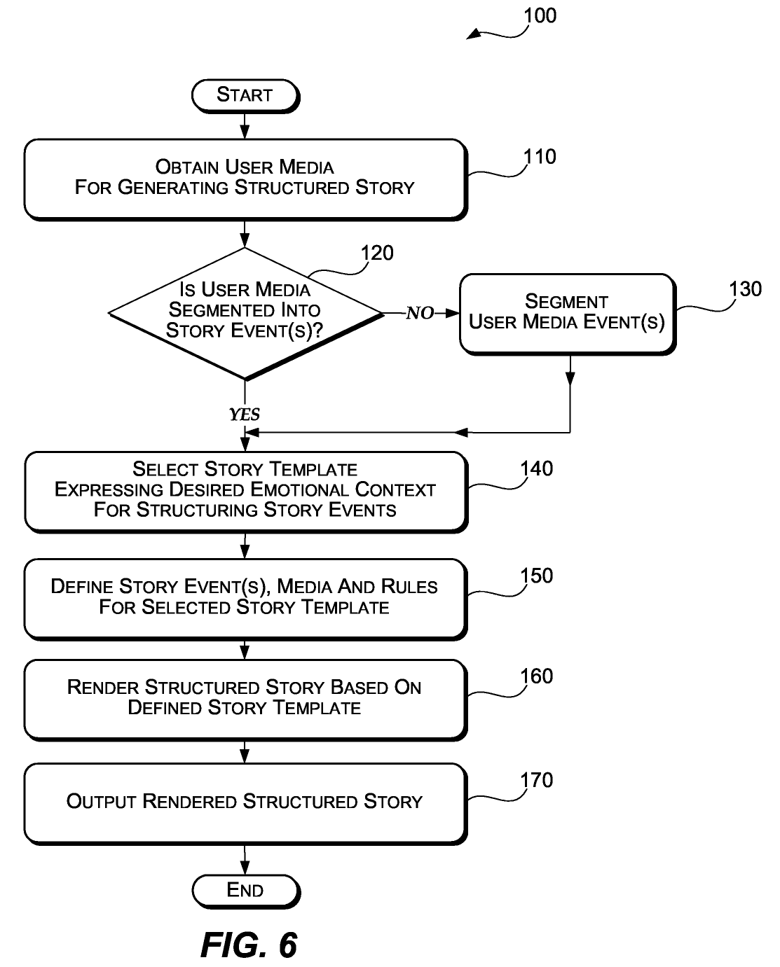

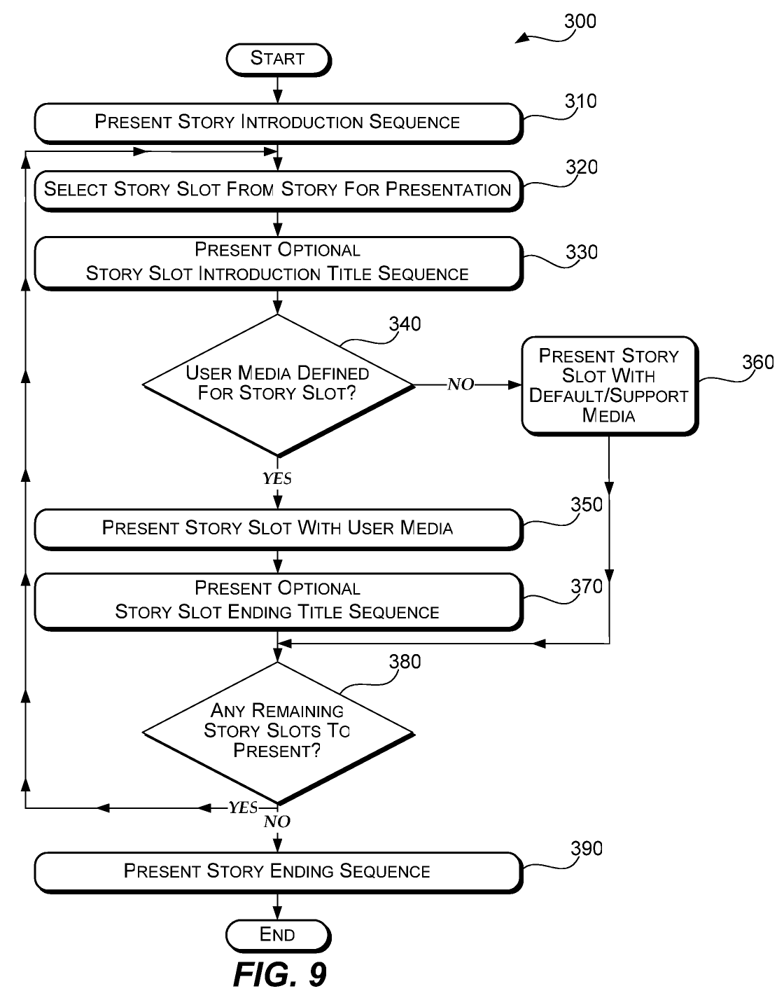

Computer processor module 18 may comprise one or more devices that may access, interpret and execute instructions and other data stored in computer memory module 20 for controlling, monitoring and/or managing (hereinafter referred to as “operating” and variations thereof) computer input module 12, computer output module 14, computer communication module 16 and/or computer memory module 20 as described herein, although some or all of the instructions and other data may be stored in and/or executed by the modules themselves. Furthermore, computer processor module 18 may also access, interpret and/or execute instructions and other data in connection with performing one or more functions to implement at least a portion of story structuring system 30 and/or methods 100, 300 illustrated in FIGS. 6 and 9, respectively, although processor module 18 may perform other functions, one or more other processing devices or systems may perform some or all of these functions, and processor module 18 may comprise circuitry configured to perform the functions described herein.

Computer memory module 20 may comprise one or more types of fixed and/or portable memory accessible by computer processor module 18, such as ROM, RAM, SRAM, DRAM, DDRAM, hard and floppy-disks, optical disks (e.g., CDs, DVDs), magnetic tape, ferroelectric and ferromagnetic memory, electrically erasable programmable read only memory, flash memory, charge coupled devices, smart cards, or any other type of computer-readable media, which may be read from and/or written to by one or more magnetic, optical, or other appropriate reading and/or writing systems coupled to computer processor module 18 and/or one or more other processing devices or systems.

Computer memory module 20 may store at least a portion of the instructions and data that may be accessed, interpreted and/or executed by computer processor module 18 for operating computer input module 12, computer output module 14, and computer communication module 16, although some or all of the instructions and data may be stored elsewhere, such as in the modules themselves and/or the computer processor module 18. Furthermore, computer memory module 20 may also store one or more instructions that may be accessed, interpreted and/or executed by computer processor module 18 to implement at least a portion of story structuring system 30 and/or methods 100, 300 illustrated in FIGS. 6 and 9, respectively, although one or more other devices and/or systems may access, interpret and/or execute the stored instructions. The one or more instructions stored in computer memory module 20 may be written in one or more conventional or later developed programming languages or other expressed using other methodologies.

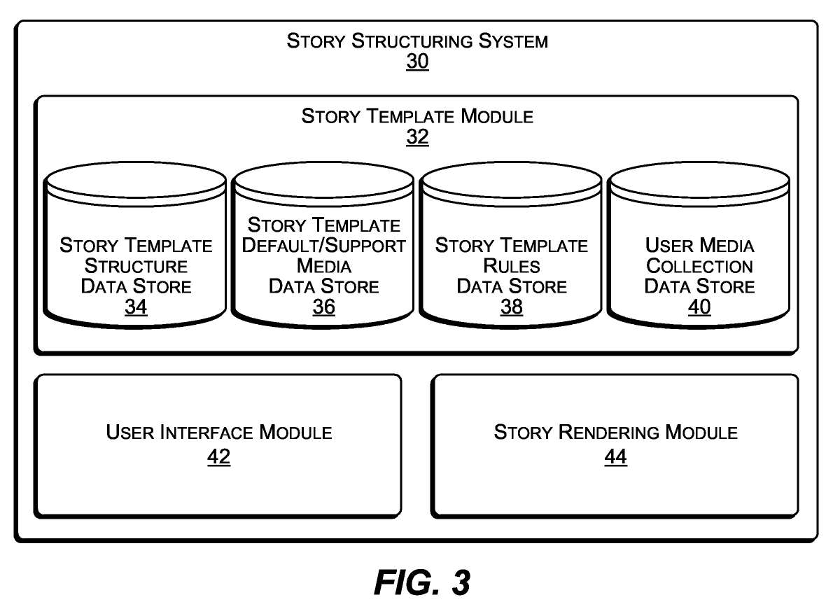

Referring now to FIG. 3, an exemplary implementation of story structuring system 30 is shown as comprising several modules including story template module 32, user interface module 42 and story rendering module 44. Generally, one or more instructions stored in computer memory module 20 may be executed by computer processor 18 to implement at least a portion of the functionalities described further below in connection with modules 32, 42 and 44 in story structuring system 30, although circuitry could be configured to implement at least a portion of those functionalities. Moreover, the one or more instructions that may be executed to implement the functionalities represented by modules 32, 42 and 44 in story structuring system 30 may be stored elsewhere and/or may be executed by one or more other computing systems or devices.

It should be appreciated that story template module 32, user interface module 42 and story rendering module 44 are illustrated in FIG. 3 to provide high-level representations of the several different functionalities that may be implemented by story structuring system 30 for ease of description and illustrative purposes only. Thus, this exemplary implementation of story structuring system 30 should not be interpreted to require that only those illustrated modules 32, 42 and 44 be employed to implement story structuring system 30, since a fewer or greater number and other types of modules may be employed so long as the overall functionalities remain substantially the same as described herein.

Story template module 32 may represent a portion of the functionality implemented by story structuring system 30 for creating structured story 45 in the manner described further herein below in connection with methods 100 and 300 illustrated in FIGS. 6 and 9, respectively. Further, story template module 32 may comprise story template structure data store 34, story template default/support media data store 36, story template rules data store 38 and user media collection data store 40. Each of these data stores 34-40 will now be described herein below with continued reference to FIG. 3.

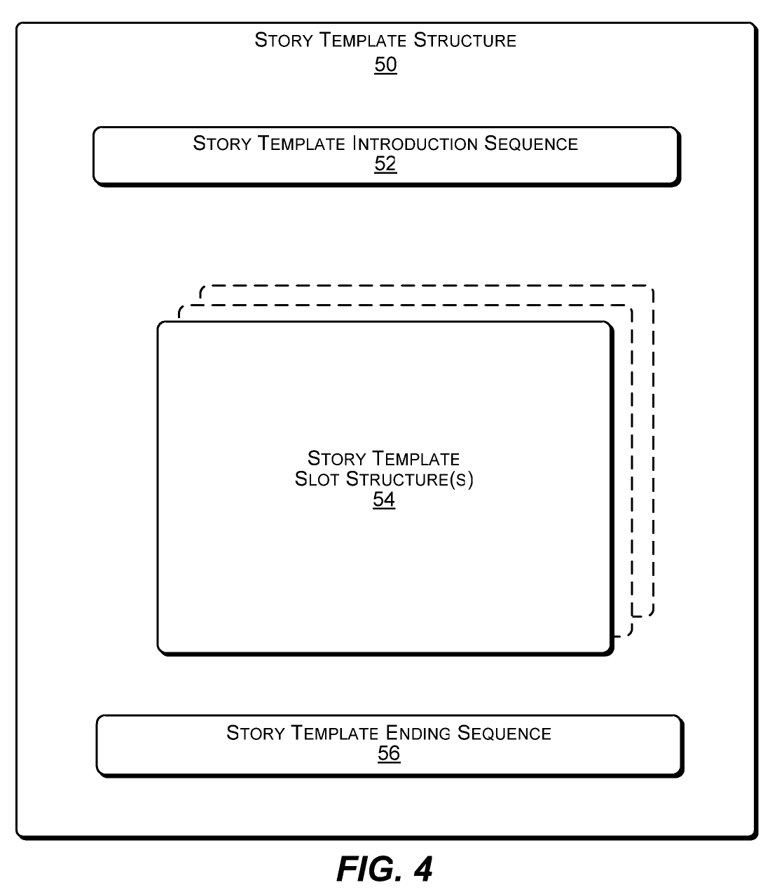

Story template structure data store 34 may store one or more story template structures 50 that may be associated with portions of story template default/support media 37 from story template structure data store 34 which may convey a well-known abstract meaning. Thus, the story template structures 50 may each be associated with a different well-known abstract meaning that may be conveyed by a particular portion of story template default/support media 37 associated with the template 50. Story template structures 50 will be described in greater detail further herein below in connection with FIG. 4.

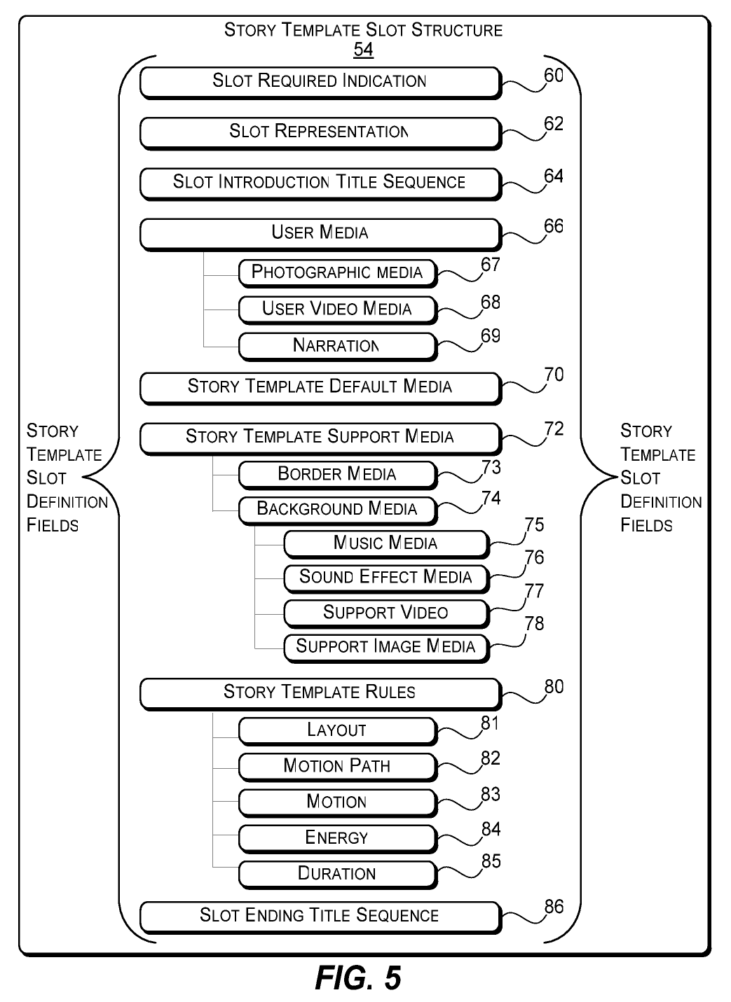

Story template default/support media data store 36 may store story template default/support media 37, which may comprise one or more portions that may each represent a variety of different types of media conveying a well-known abstract meaning, such as an emotion or a popular media theme (e.g., movie, book and video game theme). Further, one or more portions of story template default/support media 37 in data store 36 may be associated with one or more portions of a story template structure 50, which is illustrated in FIG. 4 and described in greater detail further herein below. Further, one or more portions of the story template default/support media 37 may also be associated with one or more fields in a story template slot structure 54, which is illustrated in FIG. 5 and described in greater detail further herein below.

Story template rules data store 38 may store one or more story template rules 39 that may ensure one or more portions of user media collection 41 associated with one or more story template slot structures 54 defined within one or more story template structures 50 illustrated in FIGS. 4 and 5, respectively, may be formatted in a manner substantially consistent with the well-known abstract meanings intended to be conveyed by template default/support media 37 associated with one or more template structures 50.

User media collection data store 40 may store one or more user media collections 41, which may comprise one or more portions that may each represent a variety of different types of media representing one or more story events from which users may desire sharing or otherwise communicating in the form of a narration, such as structured story 45. One or more of the story events may be subjectively associated with particular emotions, feelings, moods, thoughts, memories, or any other abstract meaning perceived by one or more users. However, the one or more story events from user media collection 41 may be associated with one or more fields in one or more story template slot structures 54 defined within a story template structure 50 as illustrated in FIGS. 4 and 5, respectively, to enable associating the story events with well-known abstract meanings conveyed by a portion of story template default/support media 37 associated with the template structure 50. Further, users may select the particular

story template structure 50 for associating the story events with based on the well-known abstract meaning that may be conveyed by the media 37 associated with the template 50 that the users may deem to substantially correspond to the abstract meanings that the users subjectively associate with the story events.

It should be appreciated that data stores 34, 36, 38, and 40 are illustrated in the manner shown in FIG. 3 for ease of description and illustration only to provide high-level representations of the different types of data that may be involved in this example of an implementation of story structuring system 30. Further, the different types of data represented by one or more of data stores 34, 36, 38, and 40 may be stored at the same location, such as at computer memory module 20, although the data represented by one or more of the data stores may be stored elsewhere.

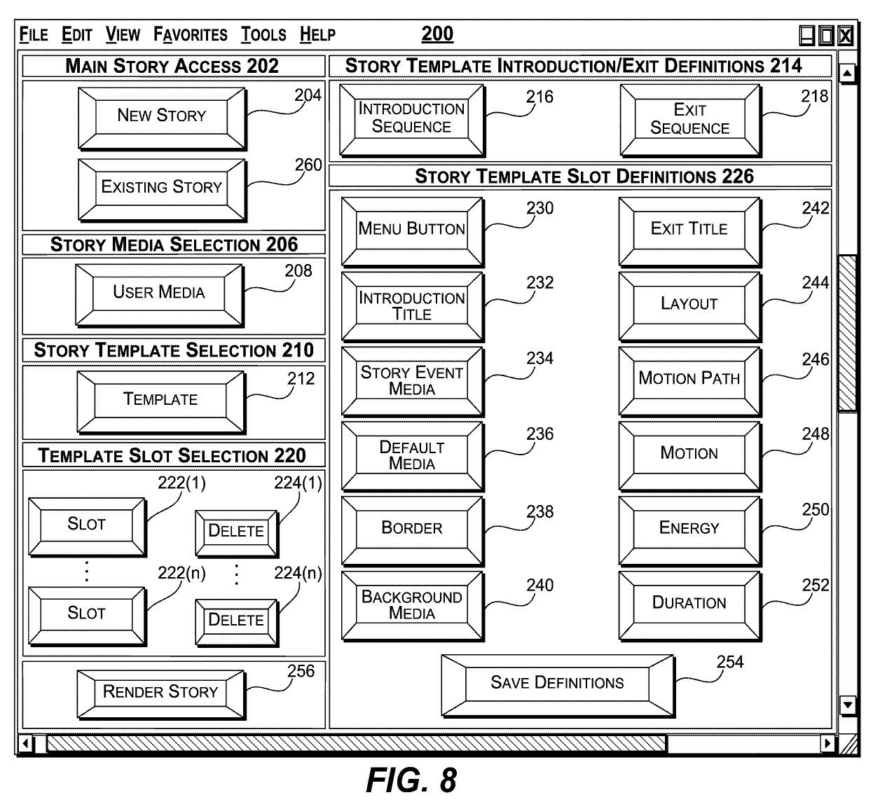

User interface module 42 may represent a portion of the functionality implemented by story structuring system 30 for generating one or more graphical user interfaces that may be employed to obtain information from one or more users that may be operating the story structuring system 30 to perform at least one of either generating a structured story 45 based on one or more story events obtained from user media 41, or presenting the structured story 45, in methods 100 and/or 300 illustrated in FIGS. 6 and 9, respectively. An example of a graphical user interface that may be employed by story structuring system 30 is illustrated in FIG. 8 and described further herein below in connection with methods 100 and 300.

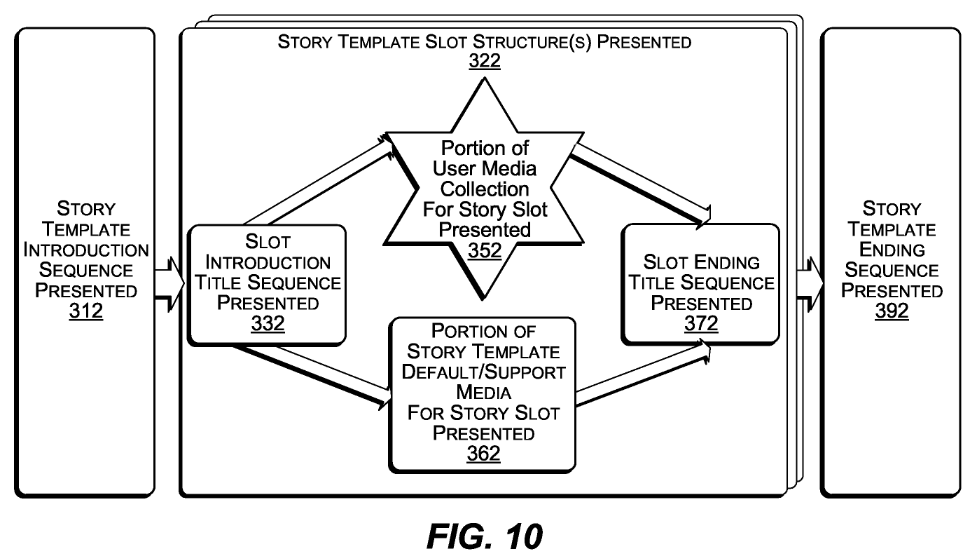

Story rendering module 44 may represent a portion of the functionality implemented by story structuring system 30 for presenting structured story 45, which will be described further herein below in connection with method 300 and FIGS. 9 and 10. Having described each of modules 32, 42 and 44 and data stores 34, 36, 38, and 40 that may be implemented in story structuring system 30 shown in FIG. 3, an example of a story template structure 50 that may be employed by story structuring system 30 will now be described below.

Referring to FIG. 4, an exemplary story template structure 50 may comprise story template introduction sequence 52, one or more story template slot structures 54 and story template ending sequence 56. Story template introduction sequence 52 may identify at least a portion of story template default/support media 37 in data store 36 that may be employed for expressing an introduction to the structured story 45 in a manner substantially consistent with the well-known abstract meaning conveyed by the sequence 52's associated portion of the media 37 presented in the sequence 52 in method 300 illustrated in FIG. 9. Further, the portion of story template default/support media 37 associated with story template introduction sequence 52 may represent a variety of different types of media, such as video and audio, for example.

Story template slot structures 54 may generally comprise one or more fields for identifying information to be associated with slot structures 54 for structuring story events obtained from user media collection 41. An exemplary implementation of story template slot structure 54 is illustrated in FIG. 5 and will be described in greater detail further herein below.

Story template ending sequence 56 may identify at least a portion of story template default/support media 37 in data store 36 that may be employed for expressing an ending to the structured story 45 in a manner substantially consistent with the well-known abstract meaning conveyed by the portion of the default/support media 37 when the sequence 52 may be presented in method 300. Further, template ending sequence 56 may use the same types of media representing the associated portion of story template default/support media 37 that may be used for the template introduction sequence 52. Having described story template structure 50, the exemplary story template slot structure 54 mentioned above will now be described in greater detail below.

Referring to FIG. 5, the exemplary story template slot structure 54 may comprise one or more story template slot definition fields 60-86. Slot required indication field 60 may identify whether the story template slot structure 54 may be deleted from story template structure 50 when generating structured story 45 or whether slot structure 54 may be required to be included in template structure 50. Slot representation field 62 may identify at least a portion of story template default/support media 37 in story template default/support media data store 36 that may be employed for depicting a structured story event associated with a particular story template slot structure 54 within a graphical representation of the layout for a structured story 45 rendered on a graphical user interface, for example.

Slot introduction title sequence field 64 may define a portion of story template slot structure 54 that may be associated with narrative content provided by a user when creating structured story 45, such as a title provided by the user in the form of text, which may be presented prior to or during presention of the story event from user media collection 44 for expressing an introduction to the story event, as described further herein below in connection with method 100 illustrated in FIG. 6, although title sequence field 64 may also identify a portion of story template default/support media 37 in story template default/support media data store 36 that may be employed for expressing the introduction.

It should be noted, however, that the slot introduction title sequence field 64 may be optional, and as such, story template slot structure 54 may be configured to define a title introduction sequence field 64 if desired for a particular slot structure 54 that may be defined within a story template slot structure 54. If a slot introduction title sequence 64 is defined for a particular slot structure 54, however, then a portion of the support default/support media 37 may be selected for expressing the story event introduction in a manner substantially consistent with the well-known abstract meaning conveyed by the story template structure 50 in which the slot structure 54 may be defined.

User media field 66 may identify one or more story events obtained from one or more portions of user media collection 41 that may be associated with story template structure 54. The user media field 66 may identify a variety of different types of media formats that the story event may be expressed in, and may include one or more subfields, such as at least one of either photographic media field 67 identifying media that may have been scanned into an electronic image medium, user video media field 68 identifying video media, or narration field 69 identifying media that may be provided by a user in the form of text, for example. Story template default media field 70 may identify a portion of story template default/support media 37 selected for story template structure 50 based on a well-known abstract meaning that may be desired to be conveyed by the story template structure 50 and any portion (i.e., story event) of user media collection that may be associated with the template structure 50.

Story template support media field 72 may identify one or more portions of story template default/support media 37 to be associated with the story event from user media collection 41 that may be selected for association with slot structure 54. Story template support media field 72 may comprise one or more subfields, such as at least one of either border media field 73 or background media field 74. Border media field 73 may identify media that may be selected for presenting a border surrounding one or more portions of the story event associated with the story template slot structure 54. Background media field 74 may identify additional media that may be selected for presenting along with the story event and may further include one or more subfields, such as at least one of either music media field 75, sound effect media field 76, support video field 77 or support image field media 78. One or more portions of story template support media field 72 may either be optional or required for a particular slot structure 54 depending on the manner in which structure 54 may be configured. Moreover, story template support media field 72 may enhance the story event from user media collection 41 and the portions of story template default/support media 37 associated with a particular slot structure 54 to help convey the well-known abstract meanings desired to be conveyed by a selected story template structure 50.

Story template rules field 80 may represent one or more media presentation formatting rules and may include one or more subfields 81-85 that may define particular rules that may be applied to a story event associated with the slot structure 54 or portions of default/support media 37 associated with the slot structure 54. Further, story template rules fields 80-85 may be configured in slot structure 54 in a manner that does not enable users to modify, define and/or delete them to help ensure the well-known abstract meanings desired to be conveyed by a selected story template structure 50 may in fact be conveyed, although the rules 80-85 could be configured in a manner that may enable users to modify, define or delete them. Further, story template rules 80-85 may be defined to have the same values for all of the slot structures 54 or the rules 80-85 may be defined to have different values for particular slot structures 54.

A layout rule field 81 may identify one or more values indicating a particular layout within a presentation interface (e.g., graphical user interface) in which the story event from media collection 41 associated with slot structure 54 at user media field 66 may be presented at method 300 illustrated in FIG. 9 and described further herein below. For instance, the layout rule field 81 may identify a portrait or landscape layout for orienting a story event associated with a particular slot structure 54 within the presentation interface, although any other type of layout for the story event may be identified.

A motion path rule field 82 may identify a particular direction on a presentation interface (e.g., graphical user interface) in which renderings (e.g., animations) associated with a story event may progress towards while the story event may be presented in method 300. The motion path rule field 82 rule may help ensure that renderings associated with one or more story events obtained from user media collection 41 may be presented in a manner in which they may appear to progress towards substantially the same direction on a presentation interface when the story events may be presented. Moreover, this may also help ensure that the story events associated with the structured story 45 may be presented in a uniform manner that may provide users with a smooth story viewing experience.

One or more other motion rules field 83 may be defined for identifying one or more other motion related formatting characteristics to be applied on any renderings associated with a story event, such as the rate in which the associated renderings may appear to progress or move at along the motion path rule field 82 in a presentation interface while the story event may be presented in method 300 and any other motion related formatting rule. The rate defined in motion rule field 83 may be specified as a frame per second value, for instance, although the rate may be specified in any other way depending on the particular formatting rule it may specifiy a value for. This may reduce the amount of variation among any motion related characteristics for one or more renderings associated with story events when presented in a structured story 45 in method 300, for example.

Energy rule field 84 may be defined for identifying at least one other formatting characteristic to be applied on any renderings associated with a story event, such as one or more values that may indicate the degree or amount of “shaky camera” or “choppy video” effects to be applied on the associated renderings. Further, the same value defined in energy rule field 84 may be defined for any renderings associated with each of the story events from media collection 41 defined in user media collection field 66 that may be associated with the story template slot structure(s) 54 in a selected story template structure 50. This may help ensure that the story events associated with the structured story 45 may be presented in a uniform manner that may provide users with a smooth story viewing experience.

Alternatively, one or more different values representing energy rule field 84 may be defined for any renderings associated with different story events in structured story 45. This may help with creating dramatic effects within structured story 45 as one or more of the story events may be presented. For instance, a high amount of shaky camera or choppy video effects may be defined for particular slot structures 54 that may be associated with a portion of story template default/support media 37 intended to convey a particular well-known abstract meaning, such as a chaotic state. On the other hand, a low amount of shaky camera or choppy video effects, such as a stable camera effect, may be defined for particular slot structures 54 intended to convey other well-known abstract meanings, such as a serene state.

Duration rule field 85 may be defined for identifying an amount of time that a story event in structured story 45 may be presented for on a presentation interface (e.g., graphical user interface). This may ensure the story events associated with the slot structures 54 in structured story 45 may be presented to a user for substantially the same amount of time to help ensure the structured story 45 may be presented in a uniform and smooth manner to a user. Alternatively, duration rule field 85 may be defined to identify different amounts of time for one or more particular slot structures 54 to achieve particular desired effects when the structured story 45 may be presented.

Slot ending title sequence field 86 may define another portion of story template slot structure 54 that may be associated other narrative content that may be provided by a user when generating structured story 45, such as another title provided in the form of text, which may be presented subsequent to or during presention of the story event for expressing an ending of the story event. It should be noted, however, that the slot ending title sequence field 86 may be optional, and as such, story template slot structure 54 may be configured to define a slot ending title sequence field 86 if desired for a particular slot structure 54 that may be defined within a story template structure 50.

If a slot ending title sequence field 86 is defined for a particular slot structure 54, however, then a portion of the support default/support media 37 may be selected for expressing the story event ending in a manner substantially consistent with the well-known abstract meaning conveyed by the story template structure 50 in which the slot structure 54 may be defined. Having described the exemplary implementation of story template slot structure 54, an example of a method 100 that may employ a selected story template structure 50 with one one or more story template slot structures 54 as described above to generate structured story 45 will now be described herein below.

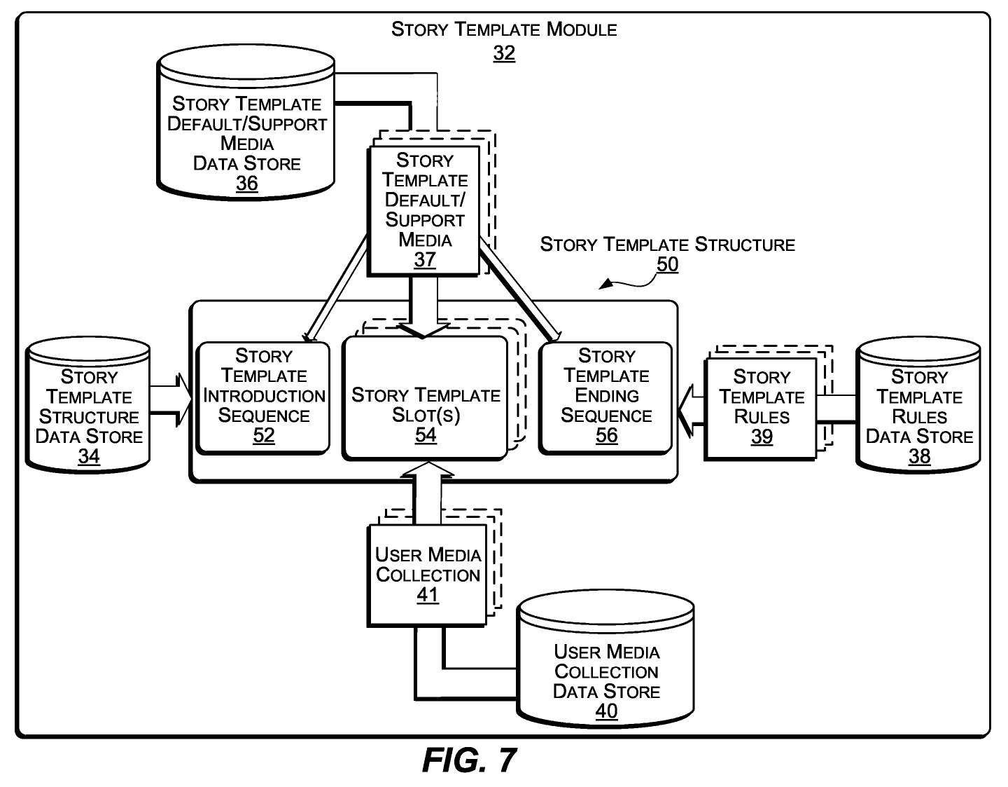

An example of a method 100 that may be implemented for structuring story events from user media collection 41 to generate structured story 45 will now be described below with reference to FIGS. 6-8 in the context of being carried out by story structuring system 30 described above in connection with FIGS. 1-5, although one or more other systems could carry out method 100 or portions thereof. Referring now to FIGS. 6 and 7, and beginning method 100 at step 110, by way of example only, a user of computer 10 may use computer input module 12, in conjunction with operation of the computer's output module 14, communication module 16, processor module 18 and memory module 20, to story structuring system 30 to begin operating.

Story structuring system 30 may respond to the user's request to begin by instructing user interface module 42 to present one or more user interfaces for presenting information to the user and for enabling the user to provide information to story structuring system 30, such as an exemplary graphical user interface (“GUI”) 200 illustrated in FIG. 8. In turn, user interface module 42 may instruct computer output module 14 to present GUI 200 using one or more of the output module 14's associated user output devices, such as a computer monitor. GUI 200 is provided for ease of illustration and description only, as any type of presentation interface besides graphical interfaces may be used. Further, the GUI 200 has been illustrated in FIG. 8 to show user interaction elements 204, 208, 212, 216, 218, 222(1)-222(n), 224(1)-224(n), 230-256 and 260 presented together in a single interface. However, the user interaction elements may be presented in a plurality of separate graphical interfaces that may be presented during one or more particular portions of method 100 or in response to one or more particular events that may occur in method 100.

Once the GUI 200 is presented, a user may request creating structured story 45 using computer input module 12 (e.g., mouse) to select the new story 204 user interaction element in a main story access 202 frame within GUI 200. Responsive to the user selection of the new story 204 element, user interface module 42 may instruct computer output module 14 to present one or more other user interfaces (not illustrated) that may be presented to instruct the user to select a user media 208 user interaction element in a story media selection 206 frame for identifying a particular user media collection 41 the user would like to use for creating the structured story 45. Responsive to the user's selections and/or additional information provided via one or more other interfaces (not illustrated) presented to the user, story template module 32 obtains the particular user media collection 41 identified by the user from user media collection data store 40, although the collection 41 may be obtained from elsewhere.

At step 120, story template module may evaluate the user media collection 41 obtained at step 110 to determine whether the media 41 may need to be segmented into one or more separate story events for associating with one or more of the story template slot structures 54 defined within a story template structure 50. If story template module 32 determines that the user media collection 41 obtained at step 110 does not need to be segmented into one or more separate story events, such as if user media collection 41 represents one or more digital pictures, for example, then the YES branch may be followed. However, if story template module 32 determines that user media collection 41 may need to be segmented, such as if user media collection 41 represents streamed video media, then the NO branch may be followed.

At step 130, story template module 32 may segment user media collection 41 into one or more separate story events based on one or more criteria that may be defined in story template module 32. For instance, if the user media collection 41 represents video media, then story template module 32 may segment the media 41 into separate story events based on one or more selected video frames, for example. In particular, story template module 32 may be configured to automatically evaluate the user media collection 41 to find one or more scene breaks.

Further, story template module 32 may be configured to segment the user media collection 41 based on one or more criteria that may define particular portions of the media 41 to select as segments, such as selecting every other video frame, or the criteria may be defined to instruct selecting portions of the media 41 located at particular time indices, such as selecting a video frame located at every other sixty second time index, for example. Additionally, story template module 32 may be configured to apply formatting to the portion of the user media collection 41 being segmented to enable the story events to appear in a more uniform manner when presented in method 300 in the form of structured story 45.

At step 140, user interface module 42 may instruct computer output module 12 to present one or more user interfaces to the user that may identify one or more different story template structures 50 in story template structure data store 34 that may convey different abstract meanings, for example, responsive to the user selecting the template 212 user interaction element in story template selection 210 frame within GUI 200 illustrated in FIG. 8. Further, the user may select a particular story template structure 50 for associating with the story events from user media collection 41 to create structured story 45. As described above earlier, story template structure 50 may be associated with one or more portions of story template default/support media 37 that may convey well-known abstract meanings, such as story themes that may correspond to popular media themes (e.g., movie, book, or video game themes) or particular emotions, for example.

For instance, a particular story template structure 50 may be associated with portions of default/support media 37 that may express a theme associated with a popular adventure game that may be known for involving many twists and turns. Further in this example, the portions of default/support media 37 for template structure 50 may represent graphics media, text, or explicit references to recognizable elements from the adventure game. If the user selected user media collection 41 at step 110 that represents digital pictures taken during a vacation that had many twists and turns, then the user may select the story template structure 50 associated with default/support media 37 expressing the theme associated with the popular adventure game in the example above.

At step 150, a user may select one or more story template slot structures 54 that may be defined for a selected story template structure 50 by selecting one one or more slot 222(1)-222(n) selection interface elements in the template slot selection 220 frame within GUI 200, which may correspond to the one or more slot structures 54. Further, the user may select one one or more selection interface elements 230-252 in the story template slot definitions 226 frame within GUI 200 for defining one or more of the story template slot definition fields 60-86 in story template slot structure 54 illustrated in FIG. 5.

For instance, the user may identify which story event obtained from user media collection 41 they would like associated with a story template slot structure 54 (i.e., user media 66 field) by selecting the story event media 234 selection interface element and selecting the particular story event from one or more other user interfaces presented by the computer output module 14. The user may also define the slot representation 62 field in story template slot structure 54 by selecting the menu button 230 selection interface element and selecting a portion of the story template default/support media 37 from one or more other user interfaces presented by the computer output module 14.

Additionally, story template module 32 may be configured to automatically implement one or more story template rules 80 in story template slot structure 54, such as layout 81, motion path 82, motion 83, energy 84 or duration 85, on one or more portions of the user media collection 41 that may be associated with the story template slot structure 54, for example. However, story template module 32 may be configured to enable users to modify one or more of these rules by selecting one or more selection interface elements 244-252 in GUI 200 and making one or more rule selections in one or more other user interfaces (not illustrated) that may be presented by the computer output module 14, although story template module 32 may be configured to not allow users to modify one or more of the rules. Furthermore, story template module 32 may be configured to obtain user input with respect to one or more rules that the module 32 may be configured to implement.

For instance, user interface module 42 may instruct computer output module 14 to present the user with one or more user interfaces (not illustrated) that may request the user to identify one or more objects within the user media collection 41 to apply one or more of the implemented rules on. More specifically, a portion of the user media 41 being associated with a particular story template slot structure 54 may include shaky video camera effects analogous to a high setting for an energy rule 84, but the rule 84 for the slot structure 54 may be defined at a comparatively lower setting. Thus, user interface module 42 may instruct computer output module 14 to present the user interfaces requesting the user to identify one or more objects within the portion of the shaky user media collection 41 on which to apply the comparatively lower setting that may be defined for the energy rule 84 of the story template slot structure 54 to automatically stabilize the one or more objects when the slot may be presented with the portion of the media collection 4141, for example.

Story template module 32 may also be configured to instruct the user interface module 42 to present the user with one or more additional user interfaces (not illustrated) for defining and/or selecting optional story template support media 72 in story template slot structure 54 that may be used to enhance the story event being associated with the slot structure 54. Still further, user interface module 42 may instruct computer output module 14 to present the user with one or more user interfaces for providing narration to define slot introduction title sequence 64 and the slot ending title sequence 86 for story template slot structure 54. It should be noted, however, that the slot introduction title sequence 64 and the slot ending title sequence 86 may be optional, and as such, the story template module 32 may be configured to make the sequences 64, 68 required or optional for a particular story template structure 50.

Story template module 32 may present the user with one or more user interfaces for providing other narration to define the story template introduction sequence 52 and the story template ending sequence 56 in the story template structure 50, although the sequences 52, 56 may be defined to be associated with a portion of the story template default/support media 37. The user may select the save definitions 254 selection interface element in GUI 200 to request the story structuring system 30 to store the user's selections and defitions provided for the story template slot structure 54. Responsive to the user's request, the story template module 32 may store the definitions provided by the user for the one or more story template slot structures 54 defined in a selected story template structure 50 in computer memory module 20, although the definitions may be stored elsewhere.

The user may also select one or more of the delete 224(1)-224(n) selection interface elements in the template slot selection 220 frame in GUI 200 shown in FIG. 8 to delete one or more corresponding story template slot structures 54 from the story template structure 50 if the slot required indication 60 field in the structure 54 permits the slot to be deleted. Story template slot structure 54 may be required to be included in story template structure 50 for a variety of reasons, such as for ensuring that the abstract meaning intended to be conveyed by the story template structure 50 is maintained. For instance, there may be particular story template slot structures 54 within a story template structure 50 that may be associated with potential story template default/support media 37 needed to maintain the conveyed meanings.

At step 160, the user may request story template module 32 to generate the structured story 45 by selecting the render story 256 selection interface element in GUI 200 shown in FIG. 8. Responsive to the user's selection, story template module 32 may format the one or more story events associated with each of the one or more story template slot structures 54 defined within story template structure 50 based on story template rules 80-85 defined for each story template slot structure 54 in the template structure 50. Further, story template module 32 may structure the formatted story events from the user media collection 41 together with the associated story template default support media 37 in each story template slot structure 54. Additionally, story template module 32 may apply any story template support media selections defined in any of the story template slot structures 54 to generate the structured story 45. The resulting structured story 45 may be rendered by story template module 32 as a video media file, such as a DVD movie, although story template module 32 may generate structured story 45 as a documentary, newsletter, slide presentation, or any other format.

At step 170, story template module 32 may present the generated structured story 45 via the computer output module 14 (e.g., display monitor) to enable the user to review the structured story 45 to ensure that they are satisfied with it. If the user is satisfied with the structured story 45, then the method 100 may end. However, if the user decides to modify the structured story 45, then the user may select the existing story 260 selection interface element in GUI 200 shown in FIG. 8 to request story template module 32 to present one or more user interfaces for selecting portions of story template structure 50 and/or story template slot structures 54 to modify. The user may continue making changes to structured story 45 until they are satisfied at which point the method 100 may end.

An example of a method 300 for presenting a structured story 45 that may have been generated by story structuring system 30 as described above in connection with FIGS. 1-8 will now be described below with reference to FIGS. 9 and 10 in the context of being carried out by story structuring system 30, although one or more other systems could carry out method 300 or portions thereof. Referring now to FIG. 9, and beginning method 300 at step 310, by way of example only, a user of computer 10 may use computer input module 12, in conjunction with operation of the computer's output module 14, communication module 16, processor module 18 and memory module 90, to story structuring system 30 to operate for presenting a structured story 45. In particular, the user may select the existing story 260 user selection element in the main story access 202 frame in GUI 200 illustrated in FIG. 8. Responsive to the user selection, story template module 32 may obtain the requested structured story 45 from computer memory module 20 and instruct the story rendering module 44 in story structuring system 30 to present structured story 45. In turn, the story rendering module 44 may instruct the computer output module 14 (e.g., display monitor) to present the story template introduction sequence 312 to the user.

At step 320, story rendering module 44 may select the next story template slot structure 54, an example of which is illustrated in FIG. 5, which may be defined for the structured story 45 selected for presentation.

At step 330, story rendering module 44 may instruct the computer output module 14 to present the story template slot structure 322 beginning with presentation of the optional slot introduction title sequence 332, if a sequence has been defined for a particular slot structure 322.

At step 340, if the story template slot structure 54 selected at step 320 is associated with a story event from user media collection 41, then the YES branch may be followed. On the other hand, if there is no story event from user media collection 41 associated with the story template slot structure 54, then the NO branch may be followed.

At step 350, the story event from the associated user media collection 41 associated with the story template slot structure 54 may be presented 352.

At step 360, the portion of the story template default/support media associated with the story template slot structure 54 may be presented 362.

At step 370, the optional slot ending title sequence may be presented 372, if a sequence has been defined for a particular slot structure 322.

At step 380, story rendering module 44 may determine whether any story template slot structures 54 defined for the structured story 45 remain for presentation. If one or more story template slot structures 54 remain, then the YES branch may be followed. On the other hand, if no story template slot structures 54 remain to be presented for the structured story 45, then the NO branch may be followed.

At step 390, story rendering module 44 may instruct the computer output module 14 to present the story template ending sequence 312 for the structured story 45 and the method 300 may end.

It should be appreciated that while computer memory module 20 illustrated in FIG. 2 has been described above as comprising computer storage media, the memory module 20 should be broadly interpreted to cover communication media as well. Communication media may embody computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example only, communication media includes wired media, such as a wired network or direct-wired connection, and wireless media, such as acoustic, RF, infrared, other wireless media, and combinations thereof.

While the disclosed technology has been described above, alternatives, modifications, variations, improvements, and substantial equivalents that are or may be presently unforeseen may arise to applicants or others skilled in the art. Accordingly, the appended claims as filed, and as they may be amended, are intended to embrace all such alternatives, modifications, variations, improvements, and substantial equivalents. Further, the recited order of processing elements or sequences, or the use of numbers, letters, or other designations therefor, is not intended to limit the claimed processes to any order except as may be specified in the claims.

What is claimed is:

1. At least one computer-readable medium having at least one instruction stored thereon, which when executed by at least one processing system, causes the at least one processing system to generate a story narration template into which an unstructured media collection can be organized to create at least one structured story for recounting at least one event captured in the unstructured media collection, the at least one stored instruction comprising:
at least one template instruction for generating at least one story narration template structure; and
at least one slot instruction for defining at least one story event slot structure in the at least one story narration template structure that associates at least a portion of the unstructured media collection with at least a portion of default content selected to convey at least a portion of a story theme.

2. The medium of claim 1 further comprising at least one story event instruction for selecting the at least one event captured in the unstructured media collection to be at least the portion of the unstructured media collection that can be associated with at least the portion of the default content based on at least one of either an event sequence index criterium or any other criterium.

3. The medium of claim 1 wherein at least the portion of the story theme conveys at least one of either a known emotional association, an emotionally significant event, or a narrative story path.

4. The medium of claim 1 wherein the story theme comprises at least one of either a selected emotional context in which to narrate at least the portion of the unstructured media collection or any other context in which to narrate at least the portion of the unstructured media collection.

5. The medium of claim 1 further comprising at least one narration instruction for defining at least one of either default structured story introduction content, default structured story ending content, or any other type of default structured story content in the at least one story narration template structure for expressing at least another portion of the story theme.

6. The medium of claim 1 further comprising at least one media formatting instruction for defining at least one media formatting rule that ensures at least the portion of the unstructured media collection associated with the at least one story event slot structure is formatted for presentation within the structured story in a manner substantially consistent with at least the portion of the associated story theme.

7. The medium of claim 6 wherein the at least one media formatting rule comprises at least one of either a motion rule, a motion path rule, an energy level rule, a duration rule, a layout rule, or any other type of media formatting rule.

8. The medium of claim 1 further comprising a slot inclusion instruction for identifying at least one selected story event slot structure that must be associated with one or more portions of the unstructured media collection as a prequisite for performing at least one of either completing, presenting or any other operation involving the structured story.

9. At least one computer-readable medium having at least one instruction stored thereon, which when executed by at least one processing system, causes the at least one processing system to implement a method for creating at least one structured story based on least one event captured in an unstructured media collection, comprising:
obtaining a story narration template structure with at least one story event slot structure associated with at least a portion of default content selected to convey at least a portion of a story theme; and
associating at least the portion of the unstructured media collection with the at least one story event slot structure to generate at least a portion of the at least one structured story.

10. The medium of claim 9 wherein the at least one event captured in the unstructured media collection is selected to be at least the portion of the unstructured media collection that is associated with at least the portion of the default content based on at least one of either an event sequence index criterium or any other criterium.

11. The medium of claim 9 wherein at least the portion of the unstructured media collection was selected for association with the at least one story event slot structure based on at least one of either a known emotional association, an emotionally significant event, a narrative story path or any other portion of the story theme conveyed by at least the portion of the default content.

12. The medium of claim 9 wherein the story narration template structure was selected from a plurality of other story narration template structures based on the story theme expressed by the default content associated with the at least one story event slot structure in the selected story narration template structure.

13. The medium of claim 9 further comprising associating narrative content with other default content associated with the at least one story event slot structure.

14. The medium of claim 13 wherein the other default content comprises at least one of either story introduction content, story ending content, or any other default content that expresses one or more other portions of the story theme.

15. The medium of claim 9 further comprising implementing at least one media formatting rule to ensure at least the portion of the unstructured media collection associated with the at least one story event slot structure is presented within the structured story in a manner substantially consistent with at least the portion of the associated story theme.

16. The medium of claim 15 wherein the at least one media formatting rule comprises at least one of either a motion rule, a motion path rule, an energy level rule, a duration rule, a layout rule, or any other type of media formatting rule.

17. The medium of claim 9 further comprising requiring that one or more portions of the unstructured media collection be associated with the at least one story event slot structure as a condition to be satisfied for performing at least one of either completing, presenting or any other operation involving the structured story.

18. The medium of claim 9 further comprising contextualizing narrative content provided to narrate at least the portion of the unstructured media collection associated with the at least one story event slot structure in a manner substantially consistent with the portion of the story theme.

19. The medium of claim 18 wherein a selected manner for contextualizing the narrative content is employed based on whether one or more portions of the narrative content conveys at least one of either a story event introduction, a story event ending or any other story event narration.

20. The medium of claim 9 further comprising associating an additional portion of the default content with the at least one story event slot structure that is selected for narrating at least the portion of the unstructured media collection.
